(19) United States
(12) Patent Application Publication
(10) Pub. No.: US 2009/0202773 A1
(43) Pub. Date: Aug. 13, 2009

(54) Flip-Over Painter's Tape

(76) Inventor: Stephen T. Burgoon, Boyertown, PA (US)

Correspondence Address: MILLER LAW GROUP, PLLC, 25 STEVENS AVENUE, WEST LAWN, PA, 19609, US

(21) Appl. No.: 12/361,271

(22) Filed: Jan. 28, 2009

Related U.S. Application Data
(60) Provisional application No. 61/027,450, filed on Feb. 9, 2008.

(51) Int. Cl. B32B 33/00; B32B 38/10; B32B 38/00

(52) U.S. Cl. 428/42.2; 428/43; 156/247

(57) ABSTRACT

A painter's tape is formed with a first portion and an adjoining second portion separated by a line of weakness that permits the first and second portions to be physically separated. The painter's tape has a layer of adhesive on one side with a removable protective strip attached to the adhesive layer on the second portion. The tape is folded along the line of weakness and applied to a first surface with the line of weakness defining a paint line between adjacent first and second surfaces. After painting the second surface, the protective strip is removed to expose the adhesive layer on the second portion, which is then flipped over to adhere to the previously painted second surface. The first portion is then removed by separating from the second portion along the line of weakness leaving the second portion to protect the second surface while the first surface is painted.

### CROSS-REFERENCE TO RELATED APPLICATIONS

This application claims domestic priority on U.S. Provisional Patent Application Ser. No. 61/027,450, filed on Feb. 9, 2008, the content of which is incorporated herein by reference.

### FIELD OF THE INVENTION

This invention relates generally to an aid for the painting of trim or other structural surfaces requiring different paint treatments, and, more particularly, to a masking tape, commonly referred to as painter's tape, where tape can be used to cover one surface and then subsequently used to cover the opposing surface without having to re-apply the painter's tape to the structural surface being painted.

### BACKGROUND OF THE INVENTION

Painters frequently use a form of masking tape, commonly referred to as painter's tape, such as the tape marketed by 3M as “Blue Painters' Tape” and the tape marketed by Henkel as “Painter's Mate Green”. These types of painter's tape typically have a milder adhesive, than conventional masking tape, on one side of the tape so that removal of the painter's tape will be facilitated without sacrificing the quality of the line that can be created with the application of the tape. Such painter's tape is typically applied to a wall or trim surface so that one edge of the tape is located immediately adjacent to the line of the surface to be painted. The applied painter's tape protects the surface to which the tape is applied from the application of paint while the paint is being applied to the adjacent surface. By having a strip of painter's tape protecting the adjacent surface that is not to be painted, the painter can “over paint” the desired surface, allowing the paint to spread on top of the painter's tape. The painter's tape is then removed from the protected surface after the paint has dried to leave a line of the painted surface corresponding to where the painter's tape was located.

Assuming that the painter then needs to paint the surface that had previously been protected, another application of painter's tape can then be applied, after the first painted surface has adequately dried, to the previously painted surface, placing an edge of the painter's tape immediately adjacent the surface to be subsequently painted. The second surface is then painted with paint being “over painted” onto the newly applied painter's tape. After allowing the newly applied paint to dry, the second application of painter's tape can then be carefully removed to expose the two painted surfaces. This dual application of painter's tape is a common practice when painting walls with trim, such as window molding, baseboard or crown molding that is to be painted with a different kind or color of paint than the wall. Another frequent dual application of painter's tape is for the joint between the walls of a room and the ceiling, where the ceiling is to be painted with a different kind or color of paint than the walls.

Painter's tape can be found in varying widths from one inch to six inches with two to four inch widths being most commonly used. The painter's tape is manufactured with a layer of adhesive on one side of the tape, and in some instances can be manufactured with the adhesive only along one edge of one side of the tape. The adhesive can be adjusted with respect to the ability of the adhesive to stick to the wall surface as some surfaces are more sensitive to adhesive pressure. For example, a wall surface that has just been painted within the preceding twenty-four hours would be more likely to be removed with the painter's tape than a wall surface that had been last painted years previously. Accordingly, some painter's tapes are provided with a lightly operative adhesive for sensitive surfaces.

Painter's tape is usually applied with significant care so that the tape is properly adhered to the surface to be protected from the application of paint, and so that the line of the painter's tape adjacent to the surface to be painted is straight and properly located, since the removal of the tape creates the paint line for the painted surface. The second application of painter's tape is even more carefully applied to the newly painted surface for the same reasons as the first application of painter's tape, and also because the newly formed paint line needs to be respected with regard to the second application of painter's tape so that there is no gap between the two respective paint lines to be formed with the removal of the second painter's tape application. Accordingly, the time required for the application of the painter's tape is a significant portion of the time spent to paint any corresponding wall surfaces.

A backing strip is disclosed in U.S. Pat. No. 4,348,440, granted on Sep. 7, 1982, to Richard Kriozere, to cover an adhesive strip formed on a pouch, such as an envelope. Double faced masking tape is taught in U.S. Pat. No. 5,098,786, issued to Jurgen Hanke on Mar. 24, 1992, wherein one area on each opposing side of the masking tape is coated with an adhesive. The tape is folded along the midline and the two adhesive coated areas are arranged so that the non-adhesive area of one side is pressed against the adhesive coated portion of the same side. The opposing side is then oriented such that the adhesive side is facing in the same direction as the adhesive portion of the opposing side of the tape. This configuration enables the tape to be easily rolled onto a dispenser and the tape can be used as a single adhesive sided tape or the top, folded portion can be removed to expose a second adhesive side.

Similarly, U.S. Pat. No. 4,582,737, granted to Gary Torgerson on Apr. 15, 1986, discloses a double surfaced adhesive tape in which two separate rolls of tape are combined onto a single roll with the adhesive coated sides facing each other on the roll so that the combined roll of tape can be stripped off the dispenser with adhesive facing in opposite directions with a small overlap area therebetween. A painter's masking tape is taught in U.S. Pat. No. 6,444,307, granted on Sep. 3, 22002, to Veijo Tuoriniemi, wherein an adhesive portion of the tape is used to mask a surface with a non-stick backing allows the tape to be dispensed from the roll easily to facilitate the application of the masking tape to the surface to be protected.

A mounting hinge tape, disclosed in U.S. Pat. No. 2,096,559, issued on Oct. 19, 1937, to Lester Riley, has adhesive applied to one side of the tape and is folded to permit one half of the tape to be affixed to a support structure, while the other half of the adhesive-coated side is attached to a movable object. The tape permits the movable object to be hingedly mounted to the support surface and moved about the hinge axis defined by the fold line in the tape. In U.S. Pat. No. 1,726,744, granted on Sep. 3, 1929, to Albert Krug, masking tape is formed with a narrow strip of adhesive on opposing sides of the masking tape, and at opposing edges, so that the tape could be mounted on a support surface while a larger barrier member could be affixed to the outwardly facing adhesive strip on the opposing side of the masking tape.

It would be desirable to provide a configuration of painter's tape that would decrease the time needed to position two applications of painter's tape to surfaces to be painted. It would also be desirable to provide a configuration of painter's tape that would provide proper respect of the paint line formed by the removal of the first application of painter's tape without sacrificing the quality of the painted surfaces.

### SUMMARY OF THE INVENTION

It is an object of this invention to overcome the disadvantages of the prior art by providing a painter's tape that can be used to cover sequentially adjacent surfaces for the application of paint thereto.

It is another object of this invention to provide a painter's tape that includes a first portion that is applied to a first surface to facilitate painting of an adjacent second surface, and a second portion that can subsequently be applied to the painted second surface to allow the first portion to be removed to facilitate painting of the first surface.

It is a feature of this invention that the first and second portions of the painter's tape are integrally formed.

It is another feature of this invention that a line of weakness is located between the first and second portions of the painter's tape.

It is an advantage of this invention that the line of weakness allows the first portion of the painter's tape to be separated from the second portion.

It is another advantage of this invention that the line of weakness allows the first portion to be separated from the second portion after the second portion has been applied to an adjacent surface so that the first portion can be removed.

It is still another feature of this invention that the painter's tape has a layer of adhesive applied to one side thereof covering both the first and second portions.

It is yet another feature of this invention that the adhesive layer on the second portion is protected by a removable strip.

It is still another advantage of this invention that the removable strip can be removed from the second portion to expose the adhesive layer thereon immediately prior to applying the second portion to the adjacent surface.

It is yet another advantage of this invention that the removable strip allows paint to be applied to the second portion of the painter's tape while the first portion is secured to the first surface without contaminating the layer of adhesive on the second portion.

It is still another object of this invention to provide a painter's tape that can be placed accurately once to enable applications of paint to two adjacent surfaces without requiring a second accurate placement of the painter's tape.

It is yet another object of this invention to provide a painter's tape that is formed with first and second portions separated by a line of weakness that allows the first and second portions to be selectively separated, the first portion having an exposed adhesive layer for securing the tape to a first surface to define a paint line and the second portion having an adhesive layer covered by a removable strip to allow the second portion to be secured to an adjacent second surface and the first portion to be detached to expose the first surface for subsequent painting.

It is a further object of this invention to provide a method of painting two adjacent surfaces at subsequent times with a single application of painter's tape to define a paint line between the two adjacent surfaces.

It is a further feature of this invention that the method of painting includes the steps of removing the removable strip from the second portion to expose the adhesive layer thereon and flipping the second portion onto the adjacent second surface before detaching the first portion from the second portion to maintain the defined paint line.

It is a further advantage of this invention that time to paint adjacent surfaces is reduced because the painter's tape does not have to be applied along the defined paint line a second time to protect the previously painted second surface while painting the first surface.

It is still a further advantage of this invention that the paint line defined by the application of the painter's tape on the first surface is maintained for the painting of the second surface without requiring a reapplication of painter's tape along the defined paint line.

It is still a further object of this invention to provide a painter's tape, and a method of painting, that will reduce paint preparation time by requiring only one application of the tape to permit painting of two adjacent surfaces, which is durable in construction, inexpensive of manufacture, facile in assemblage, and simple and effective in use.

These and other objects, features and advantages are accomplished according to the instant invention by providing a painter's tape that is formed with a first portion and an adjoining second portion separated by a line of weakness that will permit the first and second portions to be physically separated. The painter's tape has a layer of adhesive on one side with a removable protective strip attached to the adhesive layer on the second portion. The tape is folded along the line of weakness and applied to a first surface with the line of weakness defining a paint line between adjacent first and second surfaces. After painting the second surface, the protective strip is removed to expose the adhesive layer on the second portion, which is then flipped over to adhere to the previously painted second surface. The first portion is then removed by separating along the line of weakness leaving the second portion to protect the second surface while the first surface is painted.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a perspective view of a painter's tape incorporating the principles of the instant invention applied to the surface of a wall immediately adjacent to a window trim molding which is to be painted with a first paint while the wall surface is to be protected from the application of the first paint thereon;

FIG. 2 is an enlarged portion of the perspective view of the painter's tape applied to a wall surface adjacent to a window trim molding as shown in FIG. 1;

FIG. 3 is a perspective view of the painter's tape as shown in FIG. 1, but at a stage subsequent to the window trim molding having been painted and dried, the protective backing being removed from the folded portion of the painter's tape;

FIG. 4 is an enlarged portion of the perspective view of the painter's tape with the backing in the process of being removed, as shown in FIG. 3;

FIG. 5 is a perspective view of the painter's tape similar to that of FIG. 4, but with the backing strip removed and the folded portion of the painter's tape unfolded and positioned against the window trim molding;

FIG. 6 is an enlarged portion of the painter's tape depicted in FIG. 5;

FIG. 7 is a perspective view of the painter's tape after the stage depicted in FIG. 5 with the first portion of the painter's tape being removed from the unfolded second portion along a line of weakness;

FIG. 8 is a photograph showing an enlarged portion of the painter's tape depicted in FIG. 7;

FIG. 9 is a perspective view similar to that of FIG. 7, but showing the remaining second unfolded portion of the painter's tape now adhered to the window trim molding to protect the window trim molding from being painted while the adjacent wall surface is being painted with a second paint covering;

FIG. 10 is a perspective view similar to that of FIG. 9 showing the window trim molding and the adjacent wall surface after the removal of the second unfolded portion of the painter's tape following the painting and drying of the paint applied to the wall surface;

FIG. 11 is a schematic end view of the painter's tape applied to a first wall surface similar to that shown in FIG. 1 with the first portion adhered to the first wall surface and the second portion of the painter's tape folded over the first portion with the backing strip exposed, the scale of the painter's tape being exaggerated for purposes of showing the principles of the instant invention;

FIG. 12 is a schematic end view of the painter's tape after the second portion has been unfolded with the backing strip removed so that the second portion could be adhered to the second wall surface, the first portion of the painter's tape that has been removed from the second portion being shown in phantom;

FIG. 13 is a schematic end view of the painter's tape showing the second portion folded over the first portion with the backing strip being partially removed from the second portion of the painter's tape; and

FIG. 14 is a schematic end view of the painter's tape unfolded with the backing strip located on the adhesive side of the second portion.

### DETAILED DESCRIPTION OF THE PREFERRED EMBODIMENT

Referring to the drawings, a flip-over configuration of painter's tape can best be seen. The drawings depict the application of a prototype of this flip-over painter's tape in conjunction with a portion of a wall surface and an overlying piece of trim molding, as will be described in greater detail below. One skilled in the art will understand that the environment depicted in the drawings is only representative, as the invention will have utility in many different applications. For example, the flip-over painter's tape described below would be particularly adapted for used when two wall surfaces are being painted with different types or colors of paint, such as the wall of a room joined with the ceiling when both the wall and the ceiling are being painted. Another specific application for the instant invention would be a planar wall surface that is to be painted in stripes or patterns of different texture or color.

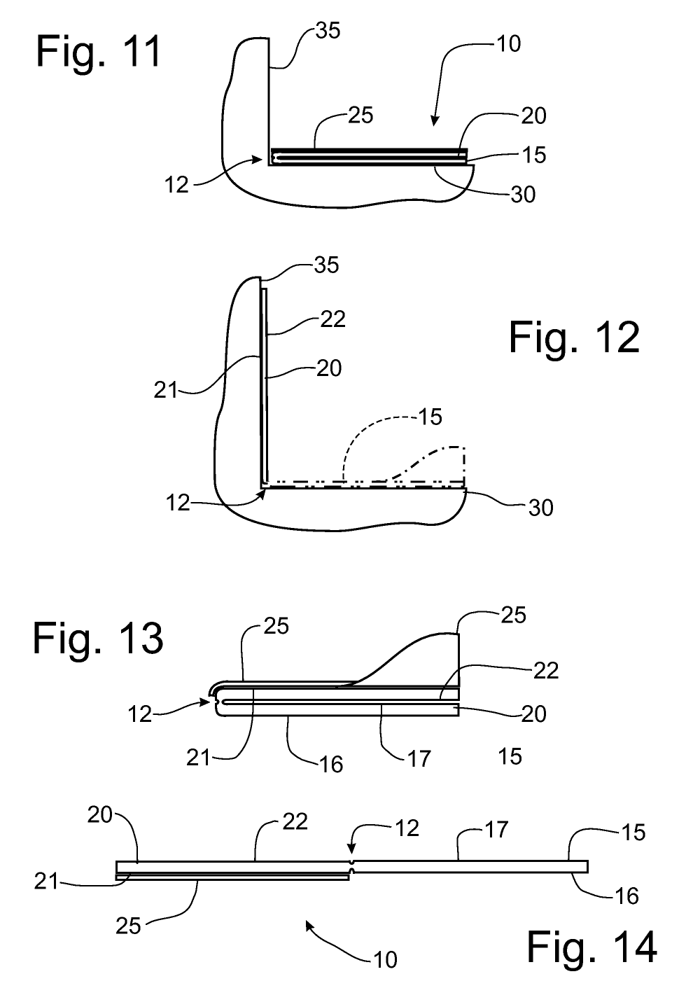

Referring first to FIGS. 11-14, a schematic representation of the painter's tape incorporating the principles of the instant invention can best be seen. The scale of the painter's tape 10 shown in FIGS. 11-14 is exaggerated to demonstrate the structural properties of the tape 10. The painter's tape 10 is formed with a conventional width, perhaps 2 or 4 inches, with an adhesive coating being applied to one side as is generally conventional for painter's tape. The adhesive is a light adhesive coating that will adhere to the surface to which it is applied, which can be a previously painted surface, bare or primed drywall, bare or primed wood, glass, etc., without causing damage to the surface when the painter's tape is removed. Such adhesive technology is well known in the art.

The tape 10 is formed with a fold/tear line 12 that is also a line of weakness that will permit the tape 10 to be separated at the fold/tear line 12, as will be described in greater detail below. The fold/tear line 12 can be a finely perforated line, but perforations would not be considered preferable as the tear separation would not be a straight edge that would provide a fine paint line once the tape is separated along the fold/tear line 12. Furthermore, the perforations can allow seepage of paint or paint components through the perforation holes that could provide dissatisfactory painting results. Thus, a line of weakness 12, preferably formed as a thinned or scored line in the material as depicted in FIG. 14, separates a first portion 15 of the tape 10 from a second portion 20, with the first and second portions 15, 20, preferably being substantially the same width, while the length is selected in a conventional manner by cutting or tearing transversely across the tape 10 to conform to the specific job to which the painter's tape 10 is being applied.

The first and second portions 15, 20 have an adhesive side 16, 21 and a non-adhesive side 17, 22. The adhesive sides 16, 21 have the light adhesive coating applied thereto, while the non-adhesive side 17, 22 is devoid of adhesive, except as described below to hold the first and second portions 15, 20 in the folded condition. The second portion 20 of the tape 10 is provided with a protective backing strip 25 that is applied to the adhesive coating on the adhesive side 21 to cover the adhesive coating and prevent the adhesive coating from being exposed until the backing strip 25 is removed. The adhesive side 16 of the first portion 15 is uncovered and separates from the backing strip 25 when pulled off the roll, assuming that the tape 10 is folded prior to being placed on a roll to be distributed in the marketplace and placed into the hands of the consumer.

The second side 20 with the backing strip 25 is folded about the line of weakness/folding line 12 over top of the first portion 15 to the configuration shown in solid lines in FIG. 13. To keep the two non-adhesive sides 17, 22 positioned against one another in the orientation shown in FIG. 13, it may be necessary to add an occasional spot of light adhesive along the non-adhesive side 17 to retain the other non-adhesive side 22 against the first portion 15. Preferably, the painter's tape is supplied for the initial application in a folded state, as shown in FIG. 13. The backing strip 25 can be easily removed from the second adhesive side 22 to expose the adhesive coating thereon to stick the second portion on a selected adjacent surface, as will be described in greater detail below.

The initial application of the painter's tape 10 is in the folded state as is preferably dispensed from the roll onto the first surface 30 to be protected from the application of paint, such as is depicted in FIG. 11. The opposing second surface 35 is then free to paint with the tape 10 protecting the first surface 30 from being over painted. After the paint on the second surface 35 has adequately dried, the backing strip 25 is removed from the adhesive side 21 of the second portion 20 to expose the adhesive coating, as is indicated in FIG. 13. The non-adhesive sides 17, 22 are then separated and the second portion is then moved about the fold line 12, which is located at the joinder of the first and second surfaces 30, 35, and placed against the second surface 35 and secured thereto.

The first portion 15 is then removed from the first surface 30 and separated from the second portion 20 along the line of weakness/fold line 12, leaving the second portion in position on the second surface 35 to prevent over painting of the second surface 35 while the first surface 30 is being painted. The second portion 20, by virtue of the line of weakness/fold line 12 being initially located at the joinder of the first and second surfaces 30, 35, is perfectly aligned with the paint line formed against the painter's tape 10 as a result of the second surface 35 being painted. After the paint on the first surface 30 has dried sufficiently, the second portion 20 can be removed carefully from the second surface 35 to reveal a straight paint line at the joinder between the first and second surfaces 30, 35.

Because of the operation described above and below will typically result in the adhesive side 22 of the second portion 20 being placed against the freshly painted second surface 35 while the first surface 30 is being painted, and because after the first surface 30 is painted and left to dry adequately the second portion 20 is removed from the freshly painted second surface 35, it would be preferable in at least one embodiment that the adhesive coating on the adhesive side 21 of the second portion 20 be a “sensitive” adhesive that will allow the second portion 20 to be removed from the second surface 35 without causing damage to the freshly painted second surface 35. The adhesive coating on the first portion 15 does not typically require the sensitivity needed for the second portion 20 as the initial application of the tape 10 to the first surface 30 is not normally on freshly painted or other sensitive surfaces. Nevertheless, alternative embodiments of the tape 10 could have sensitive adhesive coatings on both the first and second portions 15, 20, or different adhesive coatings on the first and second portions 15, 20, such as a normal adhesive on the first portion 15 and a sensitive adhesive on the second portion 20.

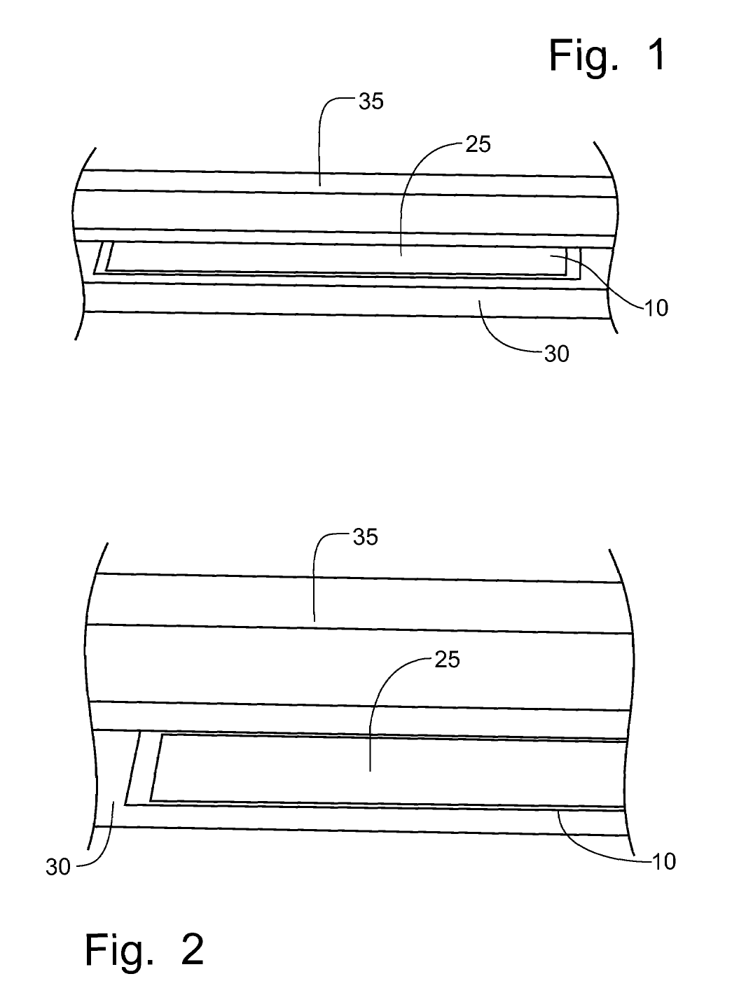

The operation of the instant invention is depicted in FIGS. 1-10. In FIGS. 1 and 2, FIG. 2 being the enlarged view, the folded over tape 10 is applied to the first surface 30 with the backing strip 25 exposed to catch the over painting from the wood trim that is the second surface 35. The adhesive side 16 of the first portion 15 is applied to the wall 30, defining the first surface, with the fold line 12 being located against the trim 35 to establish a paint line along the edge of the trim 35. The paint is then applied to the wood trim 35 with the tape 10 protecting the wall surface 30 from having paint applied thereto while paint is being placed onto the wood trim 35. Since the backing strip 25 is the top exposed surface of the tape 10, the protective backing strip 25 will have the over paint applied thereto.

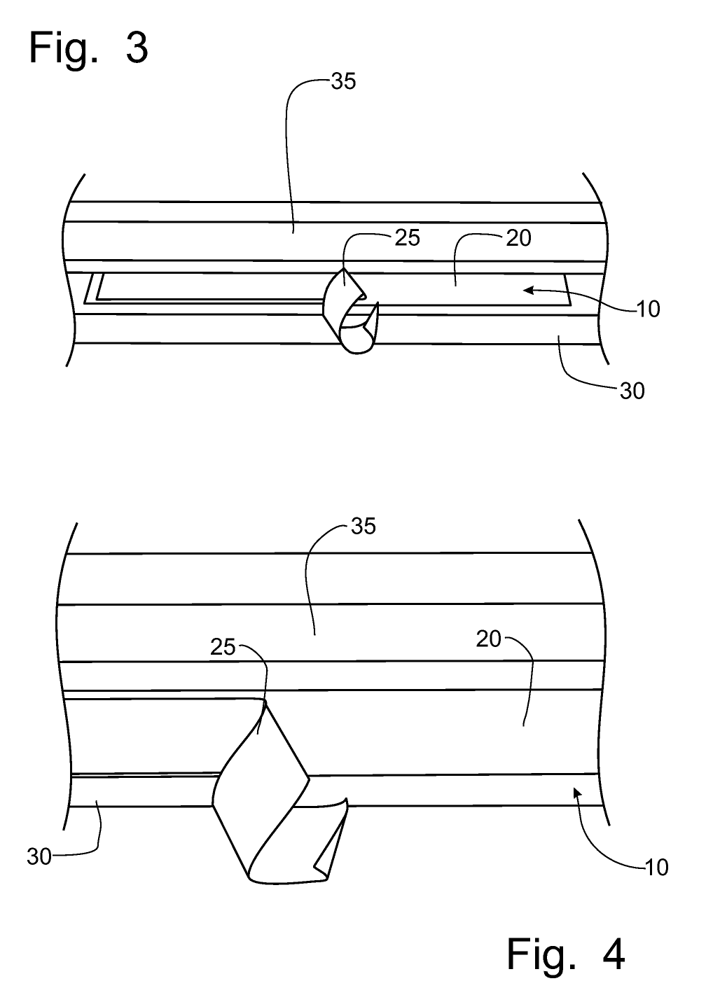

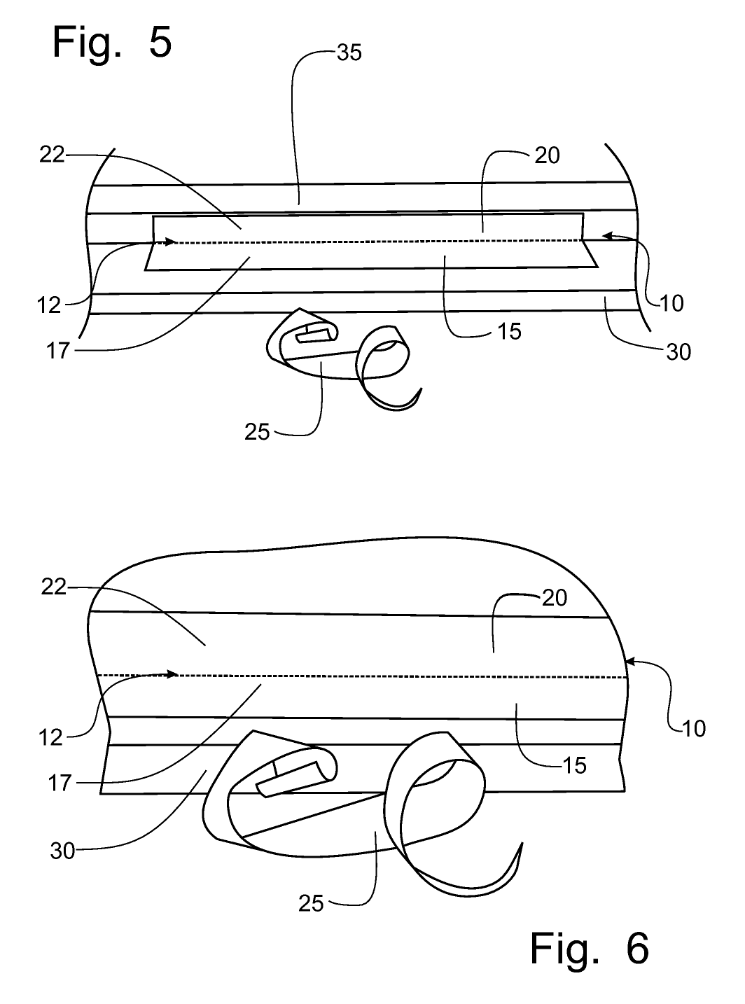

In FIGS. 3 and 4, the wood trim 35 has been painted and left to dry adequately to start the process for flipping over the second portion 20 of the painter's tape 10. The first step, as shown in FIGS. 3 and 4, is to remove the backing strip 25 to expose the adhesive side 21 of the second portion 20 of the painter's tape 10. As seen in FIGS. 5 and 6, once the backing strip 25 has been removed from the second portion 20, the second portion 20 is then unfolded from the first portion 15 about the fold line 12 to place the adhesive side 21 of the second portion 20 against the wood trim 35. The second portion 20 can be secured in place by pressing along the non-adhesive side 22 above the fold line 12 to press the adhesive coating onto the freshly painted trim 35.

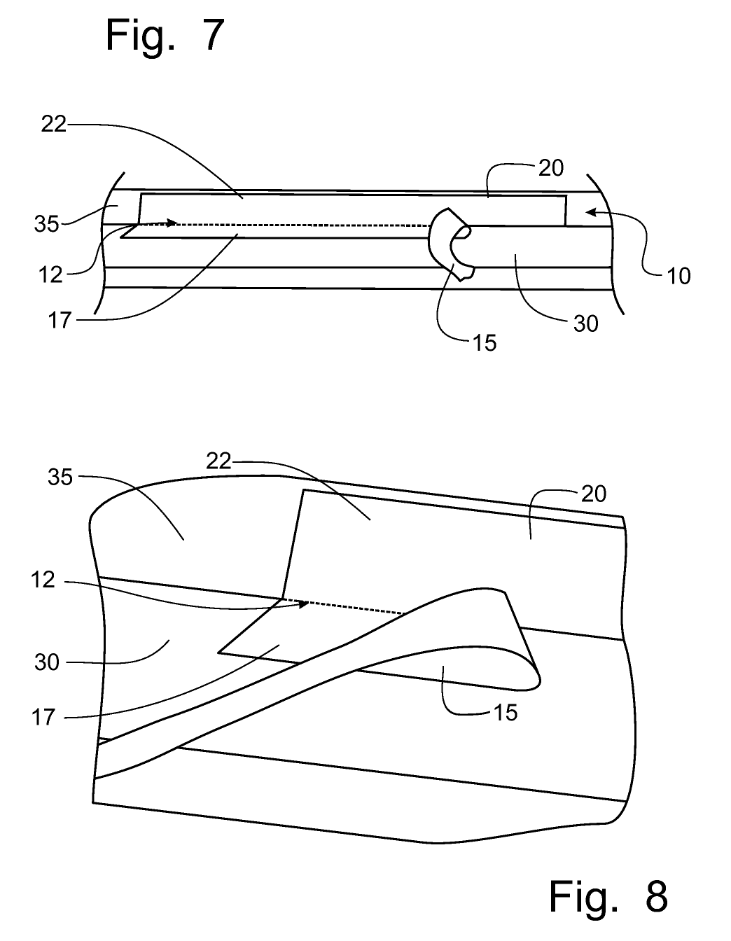

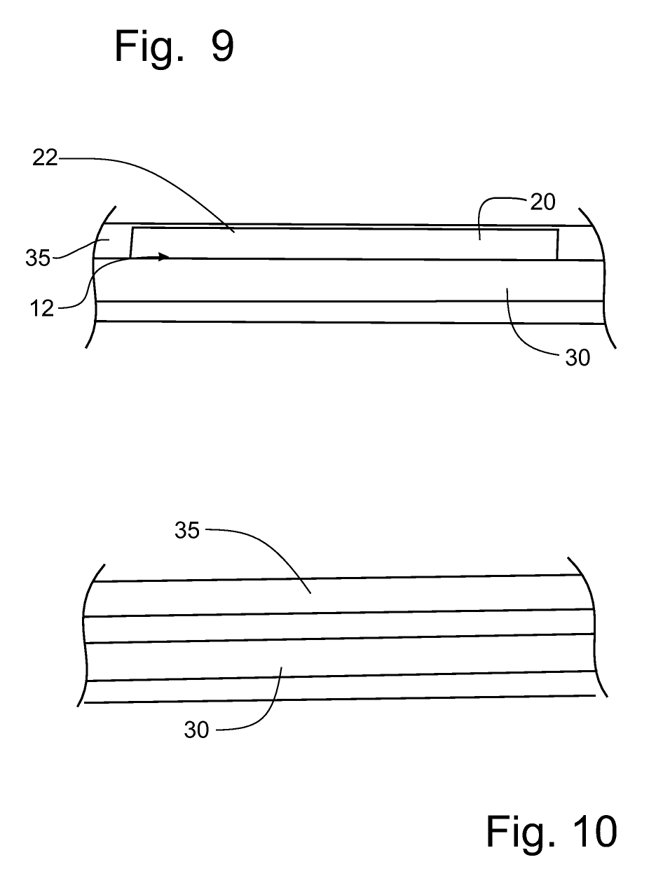

Once the second portion 20 of the painter's tape 10 is properly secured onto the wood trim 35, the first portion 15 can be removed from the wall surface 30, as is depicted in FIGS. 7 and 8, to expose the wall surface 30 to painting. The removal of the first portion 15 is accomplished by separating the adhesive coating from the wall surface 30 and then tearing the tape 10 along the line of weakness/fold line 12 to leave the second portion 20 secured to the wood trim 35 with the tear/fold line 12 being located along the paint line established during the painting of the wood trim 35 along the folded tape 10, as is depicted in FIG. 9. The wall surface 30 can then be painted with the second portion 20 of the tape 10 protecting the freshly painted wood trim 35 from over painting during the painting of the wall 30.

After the paint has been applied to the wall 30 and allowed to dry adequately, the second portion 20 of the tape 10 can be removed carefully from the wood trim 35, as is depicted in FIG. 10, to reveal the completed paint job with a straight paint line along the wood trim 35 as is desired.

The same process can be utilized to paint differently colored paint stripes on a wall surface. The folded painter's tape can be applied to the wall along the edge of one strip to be painted. After painting and allowing to dry, the second portion can be flipped over onto the freshly painted stripe, after the backing strip is removed. The subsequent removal of the first portion clears the first stripe for painting with the remaining second portion covering the freshly painted first stripe to free the other stripe for subsequent painting.

The preferred configuration of the painter's tape described above provides for equal width first and second portions. Alternative embodiments of the instant invention would provide for unequal width first and second portions, which may have the same or different adhesive coatings thereof. Since a substantial amount of painting that would typically utilize painter's tape formed according to the instant invention would entail painting interior building walls and associated trim, a consumer utilizing the painter's tape might desire to have a larger section of painter's tape on the wall to protect the wall from over painting when the trim is being painted, while the wood trim might need only a narrow strip of painter's tape to protect the freshly painted wood trim from being over painted. In such circumstances, the painter's tape could be folded along a line of weakness that is not positioned at the center of the tape. Assuming a four inch wide tape when unfolded, as shown in FIG. 14, the line of weakness/fold line could be established, for example, to form a two and a half inch first portion and a one and a half inch second portion, or some other desirable configuration.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

1. A tape product having an adhesive side and an exposed side defining an overall width dimension, comprising:
a first portion having a first width dimension less than said overall width dimension;
a second portion having a second width dimension less than said overall width dimension;
a line of weakness located between said first and second portions to permit said tape product to be folded along said line of weakness so that the exposed sides of said first and second portions are positioned back-to-back; and
a protective strip covering at least a portion of the adhesive side of said second portion.

2. The tape product of claim 1 wherein said protective strip covers substantially all of the adhesive side of said second portion.

3. The tape product of claim 1 wherein said line of weakness allows said first portion to be separated from said second portion.

4. The tape product of claim 3 wherein said first and second width dimension are substantially equal.

5. The tape product of claim 3 wherein said first width dimension is greater than said second width dimension.

6. The tape product of claim 3 wherein said line of weakness is perforated.

7. The tape product of claim 3 wherein said line of weakness is a scored line formed in the tape to induce separation along said scored line.

8. The tape product of claim 3 wherein different adhesives are applied to said first and second portions.

9. In a tape product having an adhesive side and an exposed side terminating in transversely opposed longitudinally extending edges defining a transverse width dimension, the improvement comprising:
a longitudinally extending line of weakness formed between said edges to define first and second portions on opposing sides of said line of weakness; and
a removable protective backing strip attached to the adhesive side of said second portion.

10. The tape product of claim 9 wherein said line of weakness allows said second portion to be folded over said first portion so that the exposed sides of said first and second portions are positioned back-to-back.

11. The tape product of claim 10 wherein said line of weakness also allows said first portion to be separated from said second portion.

12. The tape product of claim 11 wherein said first and second width dimension are substantially equal.

13. The tape product of claim 11 wherein said first width dimension is greater than said second width dimension.

14. The tape product of claim 11 wherein said line of weakness is a scored line formed in the tape to induce separation along said scored line.

15. The tape product of claim 11 wherein different adhesives are applied to said first and second portions.

16. A method of painting first and second adjacent surfaces to be painted in sequential stages, comprising the steps of:
applying a painter's tape to said first surface for protection of said first surface from over-painting, said painter's tape having a first portion with an adhesive side applied against said first surface, a second portion folded over said first portion, and a longitudinally extending line of weakness between said first and second portions establishing a fold line for said second portion, said line of weakness defining a paint line;
painting said second surface;
removing a protective backing strip from said second portion to expose an adhesive side of said second portion;
unfolding said second portion about said line of weakness to affix said adhesive side of said second portion to said second surface;
peeling said first portion from said first surface while separating said first portion from said second portion along said line of weakness, leaving said second portion affixed to said second surface to protect said second surface from over-painting;
painting said first surface; and
stripping said second portion from said second surface.

17. The method of claim 16 further comprising the step of allowing the paint on said first and second surfaces, respectively, to dry before said removing, peeling and stripping steps.
